(19) United States
(12) Patent Application Publication
(10) Pub. No.: US 2018/0270372 A1
(43) Pub. Date: Sep. 20, 2018

(54) OPERATION DEVICE, COMPUTER-READABLE RECORDING MEDIUM, AND DEVICE MANAGEMENT SYSTEM

(71) Applicant: Kaoru Shibuya, Kanagawa (JP)

(72) Inventor: Kaoru Shibuya, Kanagawa (JP)

(73) Assignee: Ricoh Company, Ltd., Tokyo (JP)

(21) Appl. No.: 15/920,904

(22) Filed: Mar. 14, 2018

(30) Foreign Application Priority Data
Mar. 16, 2017 (JP) 2017-051981

(51) Int. Cl. H04N 1/00

(52) U.S. Cl. CPC H04N 1/00503; H04N 1/00344; H04N 1/0097; H04N 1/00244; H04N 1/00973; H04N 1/00493

(57) ABSTRACT

An operation device operate an image forming apparatus, and includes: an operation unit including a display unit that displays an image and a reception unit that receives an input corresponding to a position of the display unit; a storage unit that stores therein position information indicating a position of an operator image on the display unit for executing a function installed in the image forming apparatus and the operation device in association with identification information indicating the corresponding function; and a processor configured to: cause the display unit to display the operator image corresponding to the identification information thereon, according to the position information and the identification information stored in the storage unit in association with each other; acquire the identification information and the position information associated with the identification information from outside; and cause the storage unit to store therein the identification information and the position information.

### CROSS-REFERENCE TO RELATED APPLICATIONS

The present application claims priority under 35 U.S.C. § 119 to Japanese Patent Application No. 2017-051981, filed on Mar. 16, 2017. The contents of which are incorporated herein by reference in their entirety.

### BACKGROUND OF THE INVENTION

### 1. Field of the Invention

The present invention relates to an operation device, a computer-readable recording medium, and a device management system.

### 2. Description of the Related Art

There has been known a technique of outputting (exporting) setting information (a set value) with respect to various functions in an image forming apparatus to an external file and another image forming apparatus reads (imports) the external file, thereby applying the setting information of the image forming apparatus at an exporting source to the another image forming apparatus (for example, Japanese Patent Application Laid-open No. 2016-091334). Due to this technique, other image forming apparatuses can reflect setting information same as that of the image forming apparatus at the exporting source.

However, according to the conventional technique, even if export and import of a set value of an application program (hereinafter, “application”) installed in a main unit of an image forming apparatus and an operation unit thereof can be performed, for example, export and import of arrangement information indicating the arrangement of operators (for example, icon images) for activating an application installed in the operation unit on an operation panel cannot be performed. For example, in the operation unit, there is a case where a specific application is registered in advance and a function key for activating the registered application in response to an operation is provided. In the conventional technique, export and import of the registration information of the application to the function key cannot be performed.

Therefore, for example, when a plurality of image forming apparatuses are operated, usability of the operation unit may be different in each of the image forming apparatuses, and thus user friendliness when a user uses one of the image forming apparatuses may be degraded.

Meanwhile, it is conceivable to employ a method of setting the arrangement of operators for activating applications on an operation panel for each of image forming apparatuses. However, when a large number of image forming apparatuses are operated, the work for setting the arrangement for each of the image forming apparatuses becomes a heavy burden.

In view of the above problems, there is a need to facilitate commonalizing of usability among a plurality of devices.

### SUMMARY OF THE INVENTION

According to an embodiment, an operation device, that operates an image forming apparatus, includes an operation unit, a storage unit, and a processor. The operation unit includes a display unit that displays an image and a reception unit that receives an input corresponding to a position of the display unit. The storage unit stores therein position information indicating a position of an operator image on the display unit for executing a function installed in the image forming apparatus and the operation device in association with identification information indicating the corresponding function. The processor is configured to cause the display unit to display the operator image corresponding to the identification information thereon, according to the position information and the identification information stored in the storage unit in association with each other; acquire the identification information and the position information associated with the identification information from outside; and cause the storage unit to store therein the identification information and the position information.

### BRIEF DESCRIPTION OF THE DRAWINGS

FIG. 1 is a block diagram illustrating a configuration of an example of a device management system applicable to an embodiment;

FIG. 2 is a block diagram schematically illustrating a configuration of an MFP applicable to the embodiment;

FIG. 3 is a diagram illustrating an example of a display on an operation panel applicable to the embodiment;

FIG. 4 is a block diagram illustrating an example of a hardware configuration of the MFP applicable to the embodiment;

FIG. 5 is a block diagram illustrating an example of a hardware configuration of an operation device applicable to the embodiment;

FIG. 6 is a block diagram illustrating an example of a hardware configuration of a server applicable to the embodiment;

FIG. 7 is a functional block diagram of an example for explaining functions of the operation device according to the embodiment;

FIG. 8 is a diagram illustrating an example in which a function designation area applicable to the embodiment is divided into six divided areas;

FIG. 9 is a block diagram illustrating a configuration of an example of an application applicable to the embodiment;

FIG. 10 is a functional block diagram of an example for explaining functions of the server according to the embodiment;

FIG. 11 is a sequence diagram of an example illustrating export processing of arrangement information according to the embodiment;

FIG. 12 is a sequence diagram of an example illustrating import processing of arrangement information according to the embodiment;

FIGS. 13A, 13B, and 13C are explanatory diagrams of a change of display in a function designation area by export processing and import processing according to the embodiment;

FIGS. 14A, 14B, and 14C are explanatory diagrams of a change of display in a function designation area by the export processing and the import processing according to the embodiment;

FIGS. 15A, 15B, and 15C are explanatory diagrams of a change of display in a function designation area by the export processing and the import processing according to the embodiment;

FIGS. 16A, 16B, and 16C are explanatory diagrams of a change of display in a function designation area by the export processing and the import processing according to the embodiment;

FIGS. 17A, 17B, 17C, and 17D are explanatory diagrams of a change of display in a function designation area by export processing and import processing according a first modification of the embodiment; and

FIG. 18 is a sequence diagram of an example illustrating import processing of arrangement information according to a second modification of the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of an operation device, a computer-readable recording medium having an operation program, and a device management system will be described below in detail with reference to the accompanying drawings.

### Embodiment

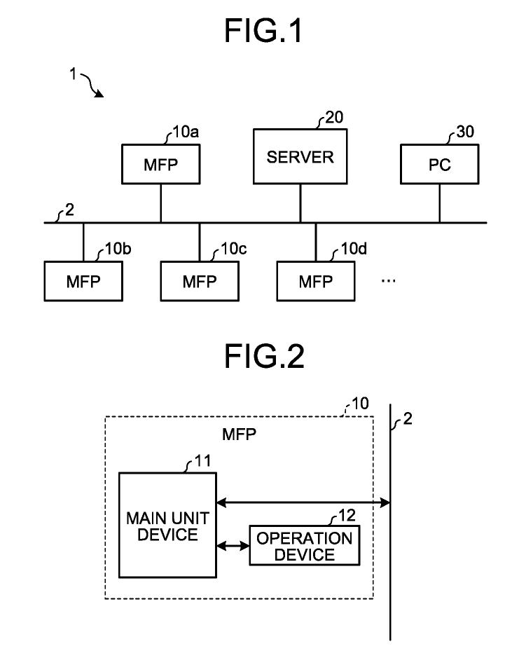

FIG. 1 illustrates a configuration of an example of a device management system applicable to an embodiment of the present invention. In FIG. 1, in a device management system 1, one or more MFPs (Multi-Function Peripherals) 10a, 10b, 10c, 10d, . . . , a server 20 as a device management system, and a PC (personal computer) 30 are connected to a network 2. The respective MFPs 10a, 10b, . . . are multifunction peripherals in which a plurality of functions such as a printer function, a scanner function, a copy function, and a FAX function are realized in one housing of the device management system 1. The server 20 manages the respective MFPs 10a, 10b, . . . that are connected to the network 2. The PC 30 can perform, for example, transmission of a printing job and the like to the respective MFPs 10a, 10b, . . . , and can access to the server 20.

In the following descriptions, the respective MFPs 10a, 10b, . . . are explained as they are collectively referred to as “MFP 10” as appropriate.

FIG. 2 schematically illustrates a configuration of the MFP 10 applicable to the present embodiment. As illustrated in FIG. 2, the MFP 10 includes a main unit device 11 and an operation device 12 including an operation panel for operating the main unit device 11 as separate units. By connecting the main unit device 11 and the operation device 12 with each other, usage as the MFP 10 becomes possible. The operation panel is a touch panel on which a display unit that displays information and a reception unit that receives an input corresponding to the position of the MFP 10 are integrally formed. The main unit device 11 is connected to the network 2. The operation device 12 can be connected to the network 2 via the main unit device 11.

An application program (hereinafter, “application”) that causes the MFP 10 to execute a predetermined function can be installed in the operation device 12. The application can be also installed in the main unit device 11. An icon image associated with the application is displayed on the operation panel of the operation device 12, and the operation device 12 activates a corresponding application in response to an operation with respect to the icon image.

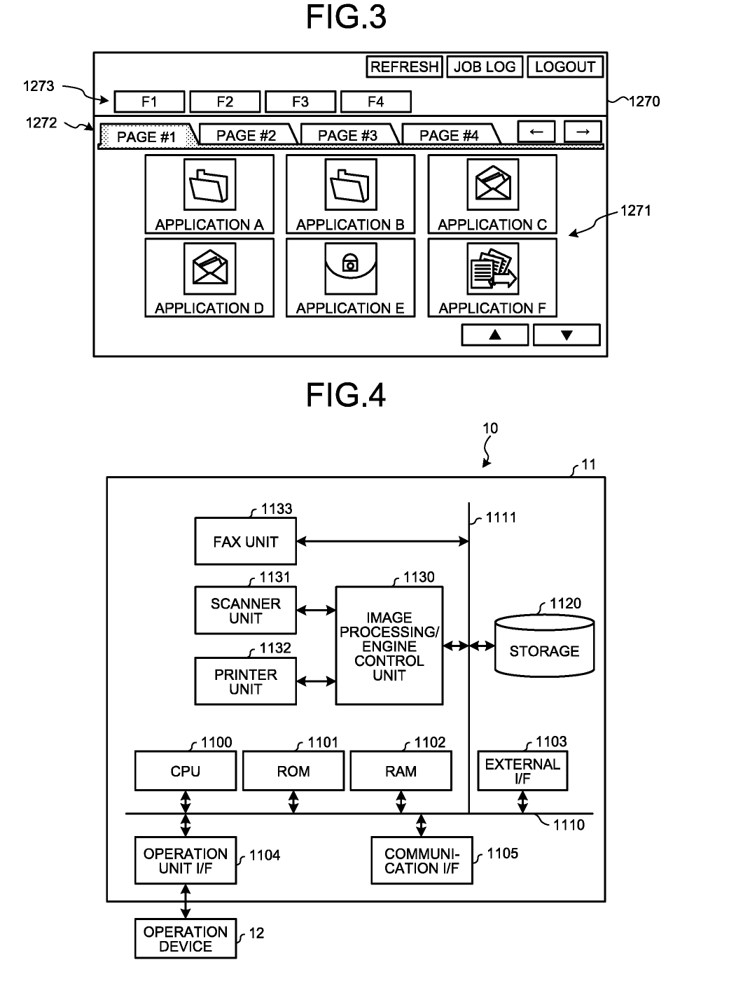

FIG. 3 illustrates an example of a display on an operation panel applicable to the present embodiment. FIG. 3 illustrates an example of a home screen 1270 for specifying an application to be activated in the MFP 10. In the operation panel, the home screen 1270 includes a function designation area 1271, a tab area 1272, and a function key area 1273.

In the function designation area 1271, icons as operator images for specifying applications to be installed in the MFP 10 are arranged. The operation device 12 activates an application associated with an operated icon in response to the operation with respect to an icon arranged in the function designation area 1271, thereby causing the MFP 10 to execute the function by the application.

In the tab area 1272, tabs for changing pages of the function designation area 1271 are provided. That is, the function designation area 1271 is managed in a unit of page capable of arranging a predetermined number of icons (in this example, six), and can include a plurality of pages respectively capable of arranging the icon images. The operation device 12 switches the display of the function designation area 1271 to a display of a page corresponding to an operated tab in response to an operation of a desired tab in the tab area 1272. Due to this operation, an icon arranged on the switched page can be operated to activate an application associated with the icon so that the function by using the application can be executed.

In the function key area 1273, one or more function keys are arranged. The function keys can register a desired application from the respective applications installed in the MFP 10. The display in the function key area 1273 is independent from the display of the function designation area 1271, and even if a page to be displayed in the function designation area 1271 is switched, the display in the function key area 1273 does not change. By using the function key area 1273, an application associated with an icon arranged on a page other than a first page can be activated quickly, for example, in the function designation area 1271.

In such a configuration, in the device management system 1 according to the present embodiment, the arrangement of icons on the respective pages in the function designation area 1271, which is displayed on the operation panel of the operation device 12 of a specific MFP 10 (assumed as the MFP 10a), can be reflected on other MFPs 10 (for example, the MFPs 10b, 10c, . . . ).

The server 20 requests arrangement information indicating the arrangement of the respective icons in the function designation area 1271 with respect to the operation device 12 of the MFP 10, for example, according to user's instruction. The operation device 12 creates an arrangement information file in which arrangement information indicating the arrangement of icons is stored in response to the request and transmits the created arrangement information file to the server 20. The processing of outputting the arrangement information file from the operation device 12 is referred to as “export”. The server 20 receives and stores therein the arrangement information file transmitted from the operation device 12.

The server 20 then requests the operation device 12 of other MFP 10 (assumed as the MFP 10b) to download the arrangement information file of the MFP 10a, for example, according to user's instruction. The processing of causing the respective operation devices 12 to download the arrangement information file is referred to as “import”. The server 20 can request import of the arrangement information file simultaneously to the MFPs 10b, 10c . . . .

The server 20 transmits the stored arrangement information file transmitted from the operation device 12 to the MFP 10b, and requests the MFP 10b to arrange the respective icons in the function designation area 1271 of the operation device 12 of the MFP 10b according to the arrangement information stored in the arrangement information file. The operation device 12 of the MFP 10b deletes arrangement information in the current function designation area 1271 in response to the request. The operation device 12 of the MFP 10b then arranges the respective icons in the function designation area 1271 according to the arrangement information read out from the arrangement information file of the MFP 10a, which has been transmitted from the server 20.

According to such processing, the arrangement of the respective icons in the function designation area 1271 in the operation device 12 of the MFP 10a is reflected on the MFP 10b. By performing identical processing with respect to the MFP 10c, the MFP 10d, . . . , in the operation devices 12 of the respective MFPs 10c, 10d, . . . , the arrangement of the respective icons at the time of activating the application can be standardized, and commonalizing of usability among the MFPs 10a, 10b, . . . can be realized. Details of configuration according to embodiment

FIG. 4 illustrates an example of a hardware configuration of the MFP 10 applicable to the present embodiment. In FIG. 4, the MFP 10 includes, in the main unit device 11, a CPU (Central Processing Unit) 1100, a ROM (Read Only Memory) 1101, a RAM (Random Access Memory) 1102, an external I/F 1103, an operation unit I/F 1104, a communication I/F 1105, and a storage 1120. The MFP 10 also has a configuration for executing the respective functions of the MFP 10.

The storage 1120 is a storage medium that stores therein data in a non-volatile manner, and a hard disk drive or a flash memory can be applied thereto. The storage 1120 stores therein a program for operating the CPU 1100 and data. The storage 1120 can also store therein the applications described above for realizing predetermined functions in the MFP 10.

In the present example in which the MFP 10 has a printer function, a copy function, a scanner function, and a FAX function, the MFP 10 includes, as constituent elements for executing respective functions, an image processing/engine control unit 1130, a scanner unit 1131, a printer unit 1132, and a FAX unit 1133. The respective units described above included in the MFP 10 are connected with each other communicably via buses 1110 and 1111.

The CPU 1100 controls the entire operation of the MFP 10 by using the RAM 1102 as a work memory, according to the program stored in advance in the ROM 1101 and the storage 1120.

The operation unit I/F 1104 is an interface for connecting the operation device 12. As the operation unit I/F 1104, for example, a USB (Universal Serial Bus) can be applied. As described above, the operation device 12 includes an input reception unit that receives a user operation and the operation panel as the operation unit including the display unit for presenting information to a user. A signal output from the operation device 12 in response to the user operation is supplied to the CPU 1100 via the operation unit I/F 1104.

The communication I/F 1105 controls communication with respect to the network 2 according to an instruction from the CPU 1100. For example, a printing job output by the PC 30 is supplied to the main unit device 11 from the communication I/F 1105 via the network 2. The external I/F 1103 is an interface for connecting an external device, such as a USB interface.

The scanner unit 1131 scans and reads an image of a document set on a platen by using an optical sensor such as a CIS (Contact Image Sensor) and outputs image data. The printer unit 1132 forms an image on a medium based on the image data by using an image forming method such as an inkjet method or an electrophotography method.

The image processing/engine control unit 1130 controls operations of the scanner unit 1131 and the printer unit 1132 according to an instruction from the CPU 1100. The image processing/engine control unit 1130 performs predetermined image processing of image data read by the scanner unit 1131 and outputs the processed image data to the bus 1111. Further, the image processing/engine control unit 1130 performs predetermined image processing of image data supplied via the bus 1111 and supplies the processed image data to the printer unit 1132. The FAX unit 1133 is connected, for example, to a public telephone line and performs FAX transmission processing of image data supplied via the bus 1111 according to an instruction from the CPU 1100.

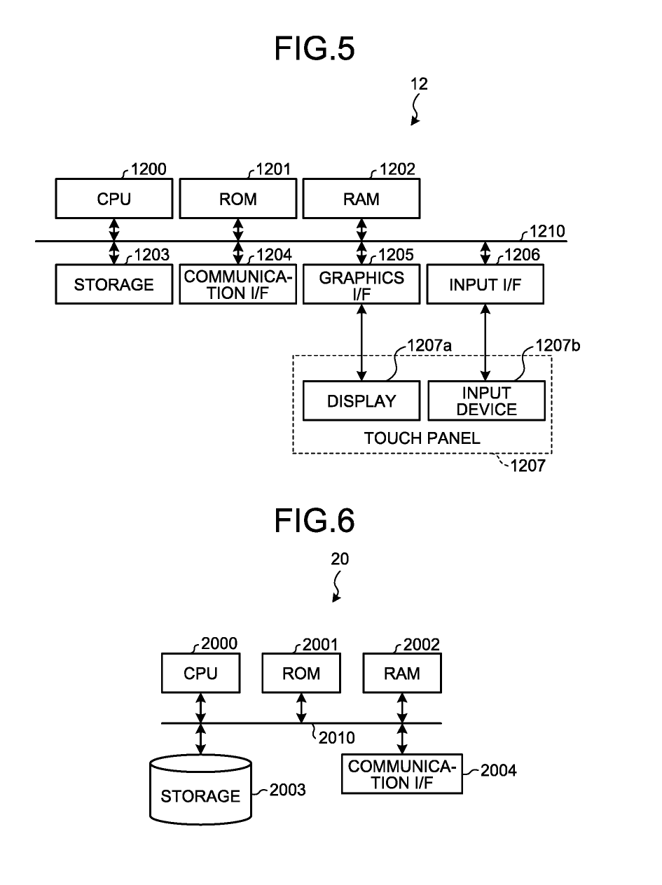

FIG. 5 illustrates an example of a hardware configuration of the operation device 12 applicable to the present embodiment. In FIG. 5, the operation device 12 includes a CPU 1200, a ROM 1202, a RAM 1202, a storage 1203, a communication I/F 1204, a graphics I/F 1205, and an input I/F 1206, and these respective units are connected with each other communicably via a bus 1210. In this manner, the operation device 12 includes the CPU 1200, the ROM 1201, and the RAM 1202 and has a configuration as a computer.

The operation device 12 also includes a display 1207a and an input device 1207b. The input device 1207b can receive an input by touch of a finger. The display 1207a and the input device 1207b are formed integrally to constitute a touch panel 1207.

The storage 1203 is configured by, for example, a non-volatile semiconductor memory, and stores therein various programs for operating the CPU 1200 and data. The storage 1203 also stores therein an application for realizing a predetermined function in the MFP 10 including the operation device 12. A hard disk drive can be applied as the storage 1203. For example, a program to be used by the operation device 12 for startup and operation and data are stored in advance in the ROM 1201. The CPU 1200 is operated by using the RAM 1202 as a work area and controls the entire operation of the operation device 12 according to the program stored in the storage 1203 and the ROM 1201.

The communication I/F 1204 is connected to the operation I/F 1104 of the main unit device 11 to control communication between the operation device 12 and the main unit device 11. By performing communication with the main unit device 11 by the communication I/F 1204, the operation device 12 is connected to the network 2 via the communication I/F 1105 of the main unit device 11. The graphics I/F 1205 converts a display control signal created by the CPU 1200 according to a program to a display signal that can be handled by the display 1207a and supplies the display signal to the display 1207a.

The display 1207a includes, for example, a LCD (Liquid Crystal Display) as a display device and a drive circuit that drives the display device according to the display signal. The input I/F 1206 converts a signal output from the input device 1207b, for example, in response to a touch operation with respect to the input device 1207b to a control signal that can be handled by the CPU 1200 and outputs the control signal to the bus 1210.

FIG. 6 illustrates an example of a hardware configuration of the server 20 applicable to the present embodiment. In FIG. 6, the server 20 includes a CPU 2000, a ROM 2002, a RAM 2002, a storage 2003, and a communication I/F 2004, and these respective units are connected with each other communicably via a bus 2010. The storage 2003 is a storage medium configured by a hard disk drive or a non-volatile semiconductor memory. The storage 2003 stores therein various programs for operating the CPU 2000 and data. The storage 2003 also stores therein information for managing the respective MFPs 10a, 10b, . . . that are connected to the network 2.

The CPU 2000 is operated by using the RAM 2002 as a work area and controls the entire operation of the server 20 according to the program stored in advance in the storage 2003 and the ROM 2001. The communication I/F 2004 controls communication via the network 2 according to an instruction from the CPU 2000.

In the example of FIG. 6, it is illustrated that the server 20 has the storage 2003 incorporated therein. However, the configuration of the server 20 is not limited to this example. For example, the storage 2003 can be an external storage device connected to the server 20 directly or via the network 2.

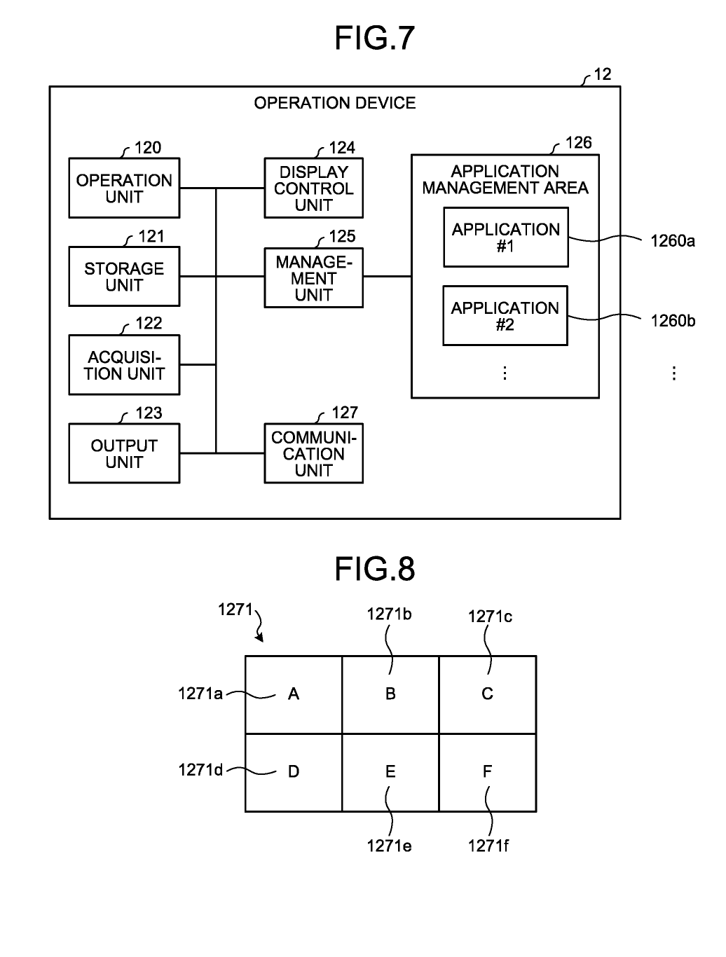

FIG. 7 is a functional block diagram of an example for explaining functions of the operation device 12 according to the present embodiment. In FIG. 7, the operation device 12 includes an operation unit 120, a storage unit 121, an acquisition unit 122, an output unit 123, a display control unit 124, a management unit 125, an application management area 126, and a communication unit 127.

Among these elements, the storage unit 1221 and the application management area 126 include, for example, a predetermined area of the storage 1203 and a control unit that performs write and read of data with respect to the storage 1203. The operation unit 120, the acquisition unit 122, the output unit 123, the display control unit 124, the management unit 125, and the communication unit 127 are realized by operating a program on the CPU 1200. The present embodiment is not limited to this configuration, and a part or all of the operation unit 120, the acquisition unit 122, the output unit 123, the display control unit 124, the management unit 125, and the communication unit 127 can be configured by hardware circuits that are operated in cooperation with each other.

A program (referred to as “operation program”) for realizing respective functions in the operation device 12 is recorded in a computer-readable recording medium such as a CD (Compact Disk), a flexible disk (FD), or a DVD (Digital Versatile Disk) as a file of an installable format or an executable format, and is provided. The method of providing the operation program is not limited thereto, and it is also possible to provide the operation program as it is stored in a computer connected to a network such as the Internet and downloaded via the network. It is also possible to configure that the operation program is provided or distributed via a network such as the Internet.

The operation program has a module configuration including the respective units described above (the operation unit 120, the acquisition unit 122, the output unit 123, the display control unit 124, the management unit 125, and the communication unit 127). As actual hardware, the CPU 1200 reads out and executes the corresponding operation programs from a storage medium such as the storage 1203 to load the respective units described above on a main storage device such as the RAM 1202, so that the operation unit 120, the acquisition unit 122, the output unit 123, the display control unit 124, the management unit 125, and the communication unit 127 are created on the main storage device.

The storage unit 121 stores therein arrangement information indicating the arrangement of respective icons on each page of the function designation area 1271 on the home screen 1270. The storage unit 121 also stores therein registration information (also referred to as “function key information”) of an application with respect to each function key in the function key area 1273 on the home screen 1270, while including the registration information in the arrangement information. As described above, for example, a predetermined area of the storage 1203 is used as the storage unit 121. The present embodiment is not limited thereto, and the storage unit 121 can be a predetermined area of the RAM 1202 or, when the ROM 1201 is rewritable, a predetermined area of the ROM 1201.

Table 1 represents an example of the arrangement information stored in the storage unit 121. As represented in Table 1, the storage unit 121 stores therein the arrangement information by associating identification information (an application ID) for identifying an application, information indicating the position of the application in the function designation area 1271, and function key information of respective function keys with each other.

TABLE 1

| APPLICATION ID | ARRANGEMENT INFORMATION |
|---|---|
| APP001 | 1-a |
| APP002 | 1-b |
| . | . |
| . | . |
| . | . |
| APP009 | 2-c |
| . | . |
| . | . |
| . | . |
| APP002 | Func-1 |
| APP005 | Func-2 |
| . | . |
| . | . |
| . | . |

In the present embodiment, the position of the function designation area 1271 is defined for each divided area obtained by dividing a predetermined area in the display 1207a. FIG. 8 illustrates an example in which the function designation area 1271 applicable to the present embodiment is divided into six divided areas 1271a to 1271f. In the respective divided areas 1271a to 1271f, one icon image for activating an application can be arranged. In the example in FIG. 8, respective icon images for activating applications A, B, C, D, E, and F are respectively arranged in the divided areas 1271a, 1271b, 1271c, 1271d, 1271e, and 1271f.

In the example of Table 1, in the arrangement information in the function designation area 1271, position information is indicated by using the page of the function designation area 1271 and a value indicating the respective divided areas. In this example, values representing the respective divided areas 1271a to 1271f are indicated as “a” to “f”, respectively. For example, an application having an application ID “APP001” is associated with position information “1-a” indicating the divided area 1271a on the first page in the function designation area 1271. An application having an application ID “APP009” is associated with position information “2-c” indicating the divided area 1271c on a second page in the function designation area 1271.

Further, in Table 1, the function key information is indicated by associating the application ID and information indicating the respective function keys with each other. For example, an application having an application ID “APP002” is associated with position information “Func-1” indicating the position of a function key in the function key area 1273 so as to configure the function key information.

Referring back to FIG. 7, the operation unit 120 receives an operation with respect to the input device 1207b of the touch panel 1207. The communication unit 127 controls the communication I/F 1204 to perform communication with the operation unit I/F 1104 of the main unit device 11. The communication unit 127 performs communication with respect to the network 2 via the communication I/F 1105 of the main unit device 11 by performing communication with the main unit device 11.

The acquisition unit 122 acquires an arrangement information file transmitted from the server 20 by communication of the communication unit 127 with the server 20. The output unit 123 creates an arrangement information file in which the arrangement information to be stored in the storage unit 121 is stored and transmits the arrangement information file to the server 20 by communication of the communication unit 127 with the server 20.

The display control unit 124 controls display with respect to the display 1207a of the touch panel 1207. The display control unit 124 controls, for example, the display on the home screen 1270 described above, thereby arranging the respective icons in the function designation area 1271 on the home screen 1270 according to the arrangement information stored in the storage unit 121 and an operation with respect to the tab area 1272. The display control unit 124 also executes display control of the function key area 1273 according to the registration information of applications with respect to the respective function keys stored in the storage unit 121.

The management unit 125 manages the respective applications 1260a, 1260b, . . . that are stored in the application management area 126. For example, the management unit 125 manages the respective applications 1260a, 1260b, . . . in association with a unique application ID. Further, the management unit 125 can manage respective applications installed in the main unit device 11 in association with application IDs in the application management area 126 in the same manner.

In FIG. 7, the respective applications 1260a, 1260b, . . . are also indicated as application #1, application #2, . . . . In the following descriptions, when there is no need to distinguish the respective applications from each other, the respective applications 1260a, 1260b, . . . are referred to as “application 1260”.

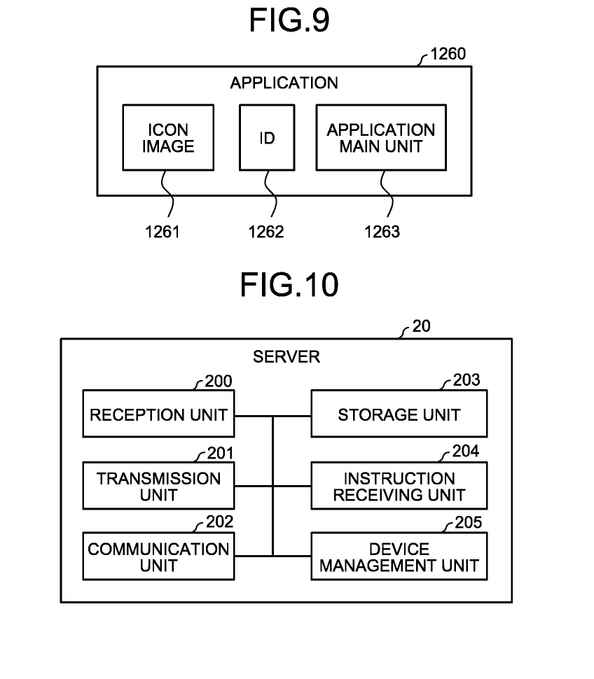

FIG. 9 illustrates a configuration of an example of the application 1260 applicable to the present embodiment. As illustrated in FIG. 9, the application 1260 includes an icon image 1261, an ID 1262, and an application main unit 1263. The icon image 1261 is an image indicating the application, and the display control unit 124 retrieves the icon image 1261 from the application 1260 and displays the icon image 1261 while arranging it in the respective divided areas 1271a to 1271f of the function designation area 1271. The ID 1262 is identification information for identifying each of the applications 1260 and is, for example, the name of the application 1260. The management unit 125 manages the respective applications 1260 by associating the ID 1262 and the application ID with each other in the application management area 126. As the ID 1262, the application ID can be used. The application main unit 1263 includes a program for executing the function of the application 1260 and data.

FIG. 10 is a functional block diagram of an example for explaining functions of the server 20 according to the present embodiment. In FIG. 10, the server 20 includes a reception unit 200, a transmission unit 201, a communication unit 202, a storage unit 203, an instruction receiving unit 204, and a device management unit 205. The reception unit 200, the transmission unit 201, the communication unit 202, the storage unit 203, the instruction receiving unit 204, and the device management unit 205 are realized by operating the programs on the CPU 2000. Furthermore, a part or all of the reception unit 200, the transmission unit 201, the communication unit 202, the storage unit 203, the instruction receiving unit 204, and the device management unit 205 can be configured by hardware circuits that are operated in cooperation with each other.

The communication unit 202 controls the communication I/F 2004 to perform communication via the network 2. The instruction receiving unit 204 receives an instruction issued, for example, by the PC 30 via the network 2. The reception unit 200 requests the arrangement information file to the operation device 12 in response to the instruction received by the instruction receiving unit 204 and receives the arrangement information file output from the output unit 123 of the operation device 12 in response to the request. The storage unit 203 includes, for example, a predetermined area of the storage 2003 and a control unit that performs write and read of data with respect to the storage 2003. The storage unit 203 stores therein the arrangement information file received by the reception unit 200. The transmission unit 201 transmits the arrangement information file stored in the storage unit 203, for example, to the respective MFPs 10 connected to the network 2 in response to the instruction received by the instruction receiving unit 204.

The device management unit 205 manages the respective MFPs 10a, 10b, . . . that are connected to the network 2. For example, the device management unit 205 manages information (for example, an IP (Internet Protocol) address and a MAC (Media Access Control) address) capable of identifying the respective MFPs 10a, 10b, . . . on the network 2 and information indicating the model of the respective MFPs 10a, 10b, . . . in association with each other. The device management unit 205 can also manage log-in information of respective users, when log-in is required at the time of use of the respective MFPs 10a, 10b, . . . .

### Specific Example of Processing According to Embodiment

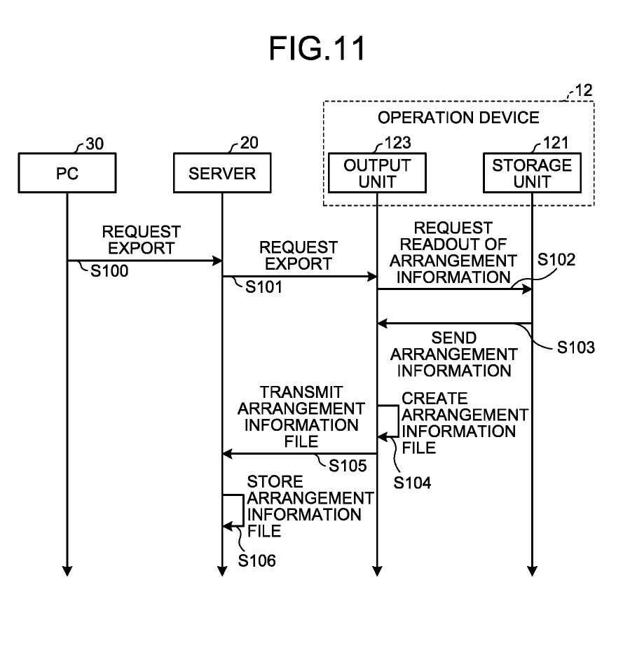

The processing in the device management system 1 according to the present embodiment is explained next more specifically. FIG. 11 is a sequence diagram of an example illustrating export processing of arrangement information according to the present embodiment. In FIG. 11, elements common to those in FIGS. 1 and 7 are denoted by like reference signs and detailed explanations thereof will be omitted. It is assumed here that a user instructs, for example, by the PC 30 to export the arrangement information stored in the operation device 12 of a specific MFP 10 (assumed as the MFP 10a).

The PC 30 instructs the server 20 to export the arrangement information of icon images for activating respective applications and function keys, which are stored in the operation device 12 of the MFP 10a in response to an operation of the user with respect to the PC 30 (Step S100). It is assumed that the user acquires in advance the pieces of information of the respective MFPs 10a, 10b, . . . that are connected to the network 2 from the server 20 by using the PC 30.

The server 20 requests the operation device 12 of the MFP 10a to export the arrangement information in response to the export request from the PC 30 (Step S101). The request is received by the communication unit 127 and sent to the output unit 123 in the operation device 12 of the MFP 10a. The output unit 123 requests the storage unit 121 to read out the arrangement information stored therein in response to the export request (Step S102). The storage unit 121 reads out the arrangement information in response to the request and sends the arrangement information to the output unit 123 (Step S103).

The output unit 123 stores the arrangement information acquired from the storage unit 121 at Step S103 in a file and creates an arrangement information file in which the arrangement information is stored (Step S104). The output unit 123 transmits the created arrangement information file to the server 20 by the communication unit 127 (Step S105). The server 20 receives the arrangement information file transmitted from the operation device 12 and stores the received arrangement information file in the storage unit 203 (Step S106). Further, the server 20 can output the arrangement information file to outside (for example, the PC 30).

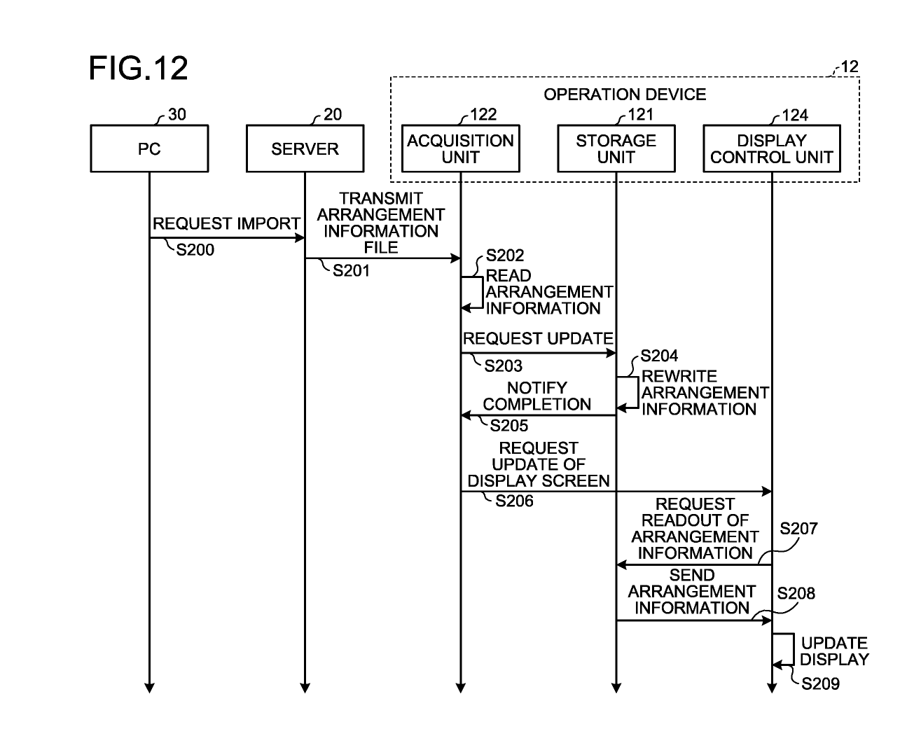

FIG. 12 is a sequence diagram of an example illustrating import processing of arrangement information according to the present embodiment. In FIG. 12, elements common to those in FIGS. 1 and 7 are denoted by like reference signs and detailed explanations thereof will be omitted. It is assumed here that the arrangement information acquired from the operation device 12 of the MFP 10a described with reference to FIG. 11 is imported to other MFPs 10b, 10c, . . . that are connected to the network 2. In the following descriptions, the MFP 10b is explained while representing the MFPs 10b, 10c, . . . .

In response to an operation of a user with respect to the PC 30, the PC 30 instructs the server 20 to import the arrangement information acquired from the MFP 10a to the MFP 10b (Step S200). The server 20 transmits the arrangement information file, which is acquired from the MFP 10a by performing the processing explained with reference to FIG. 11 and stored in the storage unit 121, to the operation device 12 of the MFP 10b in response to the import request from the PC 30 (Step S201).

The arrangement information file is received by the communication unit 127 and acquired by the acquisition unit 122 in the operation device 12 of the MFP 10b. The acquisition unit 122 reads the arrangement information from the acquired arrangement information file (Step S202). The acquisition unit 122 sends the read arrangement information to the storage unit 121 and requests the storage unit 121 to update the arrangement information stored therein by the arrangement information read at Step S202 (Step S203). The storage unit 121 deletes the arrangement information currently stored therein, and stores therein the arrangement information sent from the acquisition unit 122 to perform rewrite of the arrangement information (Step S204).

Upon completion of rewrite of the arrangement information, the storage unit 121 notifies the acquisition unit 122 of completion of rewrite (Step S205). In response to the notification, the acquisition unit 122 requests update of the display screen displayed on the display 1207a to the display control unit 124 (Step S206). The present embodiment is not limited to this example, and the storage unit 121 can send the notification of rewrite completion of the arrangement information to the display control unit 124 as an update request of the display screen.

The display control unit 124 requests readout of the arrangement information to the storage unit 121 in response to the update request of the display screen (Step S207). In response to the request, the storage unit 121 reads out the arrangement information stored therein and sends the arrangement information to the display control unit 124 (Step S208). The arrangement information sent this time is the arrangement information acquired from the operation device 12 of the MFP 10a in the processing in FIG. 11 described above. The display control unit 124 updates the display on the display 1207a according to the arrangement information sent from the storage unit 121 (Step S209).

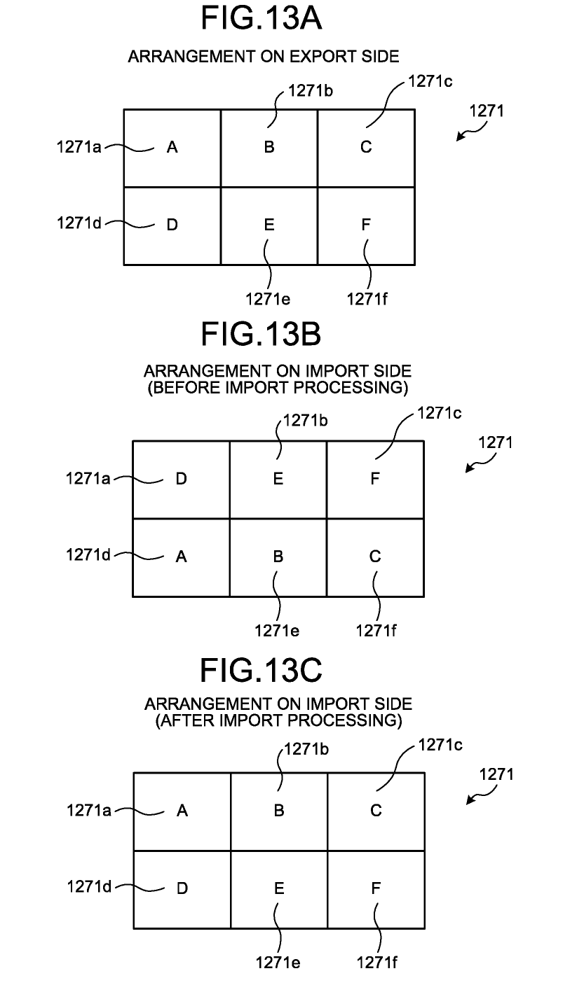

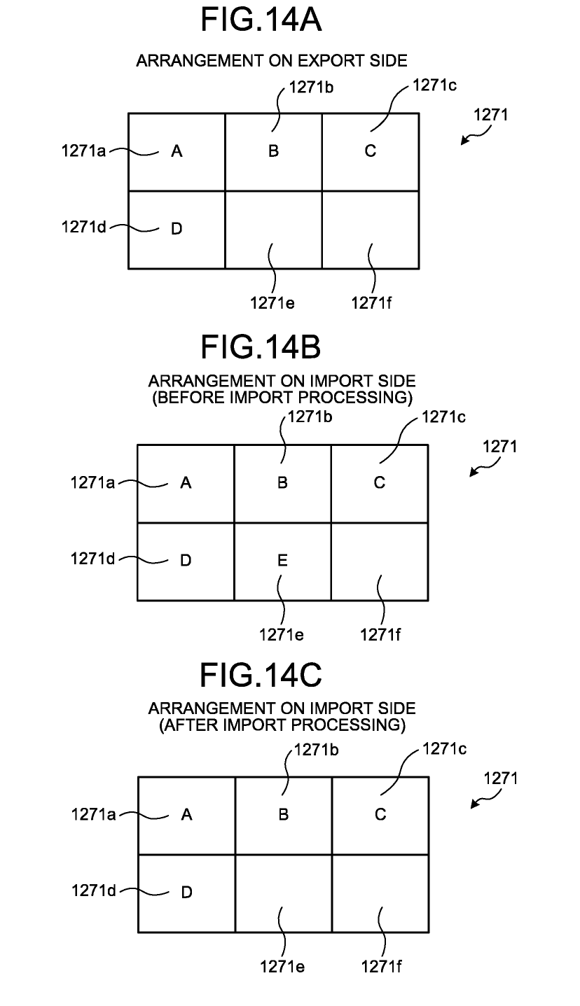

FIGS. 13A to 13C are explanatory diagrams of a change of display in the function designation area 1271 by the export processing in FIG. 11 and the import processing in FIG. 12. In FIG. 13 as well as FIG. 14 to FIG. 16 described below, the icon images of the applications A, B, . . . are illustrated as “A”, “B”, . . . , respectively.

FIG. 13A illustrates an example of arrangement of the respective icon images on the export side, that is, in the function designation area 1271 of the operation device 12 of the MFP 10a. On the export side, icon images of the applications A, B, C, D, E, and F are respectively arranged in the divided areas 1271a, 1271b, 1271c, 1271d, 1271e, and 1271f in this manner.

FIG. 13B illustrates an example of arrangement of the respective icon images in the operation device 12 of the MFP 10b before the import processing in FIG. 12 is performed. On the import side, it is assumed that the display control unit 124 arranges the icons images of the applications D, E, F, A, B, and C, respectively in the divided areas 1271a, 1271b, 1271c, 1271d, 1271e, and 1271f according to the arrangement information stored in the storage unit 121, which is an arrangement different from that on the export side illustrated in FIG. 13A.

FIG. 13C illustrates an example of arrangement of the respective icon images in the operation device 12 of the MFP 10b after the import processing in FIG. 12 is performed. As described above, in the import processing, after the arrangement information stored in the storage unit 121 is deleted, the imported arrangement information is stored in the storage unit 121 (Step S204 in FIG. 12). Therefore, in the function designation area 1271, the icon images of the applications A, B, C, D, E, and F are respectively arranged in the divided areas 1271a, 1271b, 1271c, 1271d, 1271e, and 1271f, which are in the same arrangement as that in the function designation area 1271 by the operation device of the MFP 10a on the export side.

According to the device management system 1 of the present embodiment, the arrangement information in which the respective icon images for activating the applications and the information identifying the application are associated with each other, which is arranged in the function designation area 1271, can be exported and imported. Therefore, the arrangement of icon images in the function designation area 1271 can be easily standardized and usability among the plurality of MFPs 10 can be easily commonalized.

In the above descriptions, the export processing and the import processing of the arrangement information are performed by issuing an instruction from the PC 30 to the server 20. However, the present embodiment is not limited thereto. For example, export of the arrangement information can be instructed by operating an operation panel of the operation device 12 of the MFP 10 at an exporting source (in the example described above, the MFP 10a). In this case, the operation device 12 can create the arrangement information file by performing the processes at Step S102 to Step S104 in FIG. 11 and store the created arrangement information file in a removable storage medium such as a USB memory.

Similarly, regarding the import of the arrangement information, an instruction can be issued by operating an operation panel of the operation device 12 of the MFP 10b at an importing destination (in the above example, the MFP 10b). In this case, for example, the operation device 12 reads out the arrangement information file from the removable storage medium and performs the processes at Step S202 onwards in FIG. 12.

In the examples of FIGS. 13A, 13B, and 13C described above, the MFP 10a on the export side and the MFP 10b on the import side have the same applications A to F installed therein. However, the present embodiment is not limited to this example, and the present embodiment can be also applied to a case where the applications installed in the MFP 10a on the export side and in the MFP 10b on the import side are different. When the applications installed in the MFP 10a on the export side and in the MFP 10b on the import side are different, basically, the arrangement of respective icon images in the operation device 12 of the MFP 10b on the import side is decided based on applications commonly installed in the MFP 10a on the export side and the MFP 10b on the import side.

A case where the applications installed in the MFP 10a on the export side and the MFP 10b on the import side are different in the present embodiment is described with reference to FIG. 14 to FIG. 16.

FIGS. 14A to 14C illustrate examples in which one application (the application E) among the applications installed in the MFP 10b on the import side is not installed in the MFP 10a on the export side. For example, as exemplified in FIG. 14A, it is assumed that the MFP 10a on the export side has the applications A, B, C, and D installed therein, and corresponding respective icon images are arranged in divided areas 1271a, 1271b, 1271c, and 1271d of the function designation area 1271, respectively. Meanwhile, it is assumed that the MFP 10b on the import side has the application E in addition to the applications A, B, C, and D installed therein, as exemplified in FIG. 14B, and corresponding respective icon images are arranged in divided areas 1271a, 1271b, 1271c, 1271d, and 1271e of the function designation area 1271, respectively.

In such a case, when the export processing and the import processing according to the present embodiment are performed, in the MFP 10b on the import side, the acquisition unit 122 deletes the arrangement information stored in the storage unit 121 at Step S204 in FIG. 12, and then stores the arrangement information exported from the MFP 10a in the storage unit 121. In the MFP 10b on the import side, the display control unit 124 decides the arrangement of icon images with respect to the respective divided areas 1271a to 1271f of the function designation area 1271 according to the arrangement information stored in the storage unit 121.

Therefore, as exemplified in FIG. 14C, in the respective divided areas 1271a to 1271f of the function designation area 1271, icon images of the applications A, B, C, and D commonly included in the MFP 10a on the export side and the MFP 10b on the import side are respectively arranged in the divided areas 1271a to 1271d. On the other hand, an icon image of the application E, which is installed in the MFP 10b on the import side but is not installed in the MFP 10a on the export side, is not arranged in the function designation area 1271.

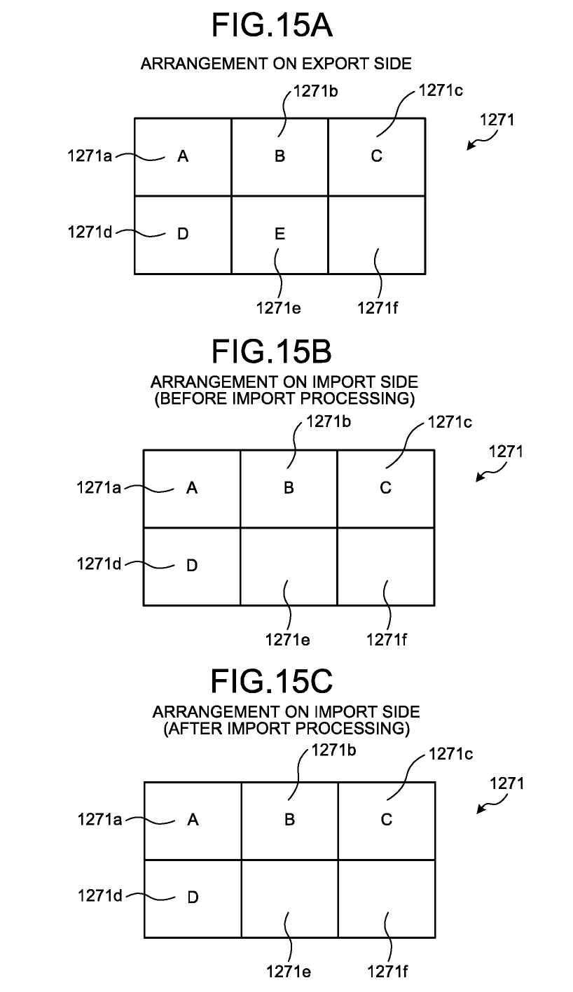

FIGS. 15A to 15C illustrate examples in which one application (the application E) among the applications installed in the MFP 10a on the export side is not installed in the MFP 10b on the import side. For example, as exemplified in FIG. 15A, it is assumed that the MFP 10a on the export side has the applications A, B, C, D, and E installed therein, and corresponding respective icon images are arranged in divided areas 1271a, 1271b, 1271c, 1271d, and 1271e of the function designation area 1271, respectively. Meanwhile, it is assumed that the MFP 10b on the import side has the applications A, B, C, and D installed therein, as exemplified in FIG. 15B, but the application E is not installed therein, and respective icon images corresponding to the applications A, B, C, and D are arranged in divided areas 1271a, 1271b, 1271c, and 1271d, of the function designation area 1271, respectively.

In this case, because the application E installed in the MFP 10a on the export side is not installed in the MFP 10b on the import side, an icon image of the application E is not present on the side of the MFP 10b. Therefore, as exemplified in FIG. 15C, icon images of the applications A, B, C, and D commonly included in the MFP 10a on the export side and the MFP 10b on the import side are respectively arranged in the divided areas 1271a to 1271d, in the respective divided areas 1271a to 1271f of the function designation area 1271.

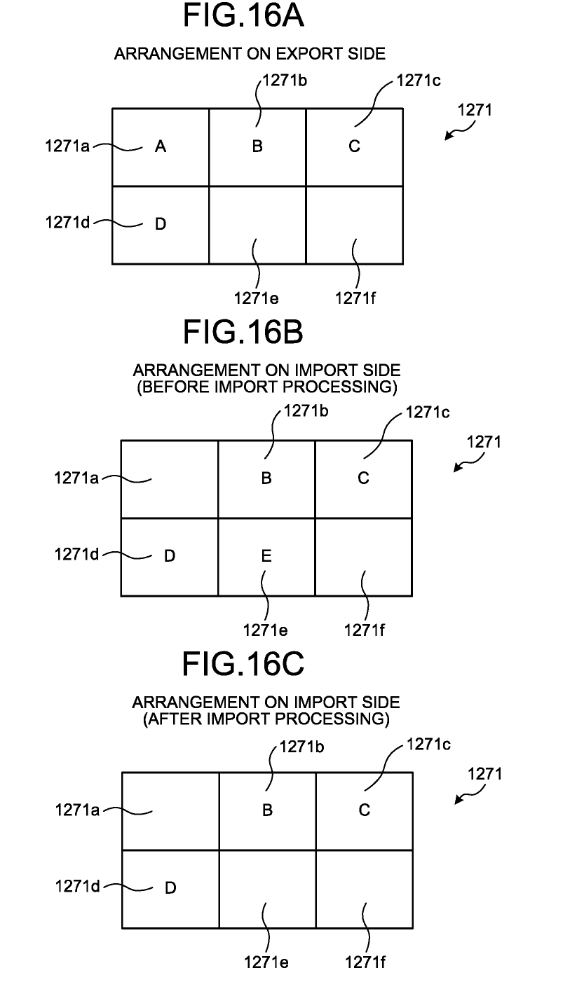

FIGS. 16A to 16C illustrate examples in which one application (the application A) among applications installed in the MFP 10a on the export side is not installed in the MFP 10b on the import side, and one application (the application E) among applications installed in the MFP 10b on the import side is not installed in the MFP 10a on the export side. For example, as exemplified in FIG. 16A, it is assumed that the MFP 10a on the export side has the applications A, B, C, and D installed therein, and corresponding respective icon images are arranged in divided areas 1271a, 1271b, 1271c, and 1271d of the function designation area 1271, respectively. Meanwhile, it is assumed that the MFP 10b on the import side has the applications B, C, and D, and E installed therein, as exemplified in FIG. 16B, and respective icon images corresponding to the applications B, C, D, and E are arranged in divided areas 1271b, 1271c, 1271d, and 1271e of the function designation area 1271, respectively.

Also in this case, in the MFP 10b on the import side, the acquisition unit 122 deletes the arrangement information stored in the storage unit 121 at Step S204 in FIG. 12, and then stores the arrangement information exported from the MFP 10a in the storage unit 121. Therefore, regarding the application E that is installed in the MFP 10b on the import side and is not installed in the MFP 10a on the export side, the icon image thereof is not arranged in the function designation area 1271 of the MFP 10b, because the arrangement information is deleted. Further, regarding the application A installed in the MFP 10a on the export side, because the application A is not installed in the MFP 10b on the import side, the icon image of the application A is not present on the side of the MFP 10b. Therefore, as exemplified in FIG. 16C, icon images of the applications B, C, and D commonly included in the MFP 10a on the export side and the MFP 10b on the import side are respectively arranged in the divided areas 1271b to 1271d, in the respective divided areas 1271a to 1271f of the function designation area 1271.

In this manner, in the present embodiment, an icon image of an application that is installed in the MFP 10b on the import side but is not installed in the MFP 10a on the export side is not arranged in the function designation area 1271 of the MFP 10b on the import side. Therefore, restriction of the functions of the respective MFPs 10b, 10c, . . . on the import side can be easily realized.

### First Modification of Embodiment

A first modification of the present embodiment is described next. The first modification of the present embodiment is an example in which, with respect to the present embodiment described above, an icon image of an application that is installed in the MFP 10b on the import side but is not installed in the MFP 10a on the export side is arranged in the function designation area 1271 of the MFP 10b on the import side. For example, this arrangement becomes possible in the MFP 10b on the import side by switching an operation mode to a mode in which the arrangement of icon images among applications with respect to the function designation area 1271 can be customized.

In this case, in the first modification of the present embodiment, the icon image of the application that is installed in the MFP 10b on the import side but is not installed in the MFP 10a on the export side is arranged in the function designation area 1271 so as not to change the arrangement of icon images among applications commonly included in the MFP 10a on the export side and the MFP 10b on the import side, in the MFP 10a on the export side.

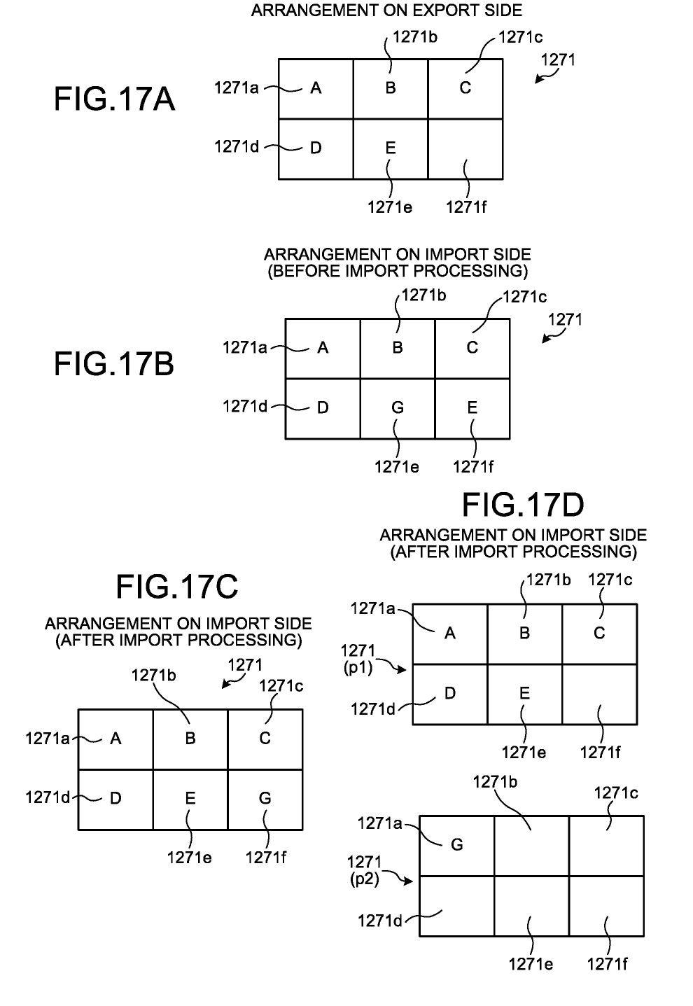

This example is explained with reference to FIGS. 17A to 17D. It is assumed that the MFP 10 (assumed as the MFP 10a) on the export side has the applications A, B, C, D, and E installed therein, and with respect to the function designation area 1271, as exemplified in FIG. 17A, icon images of the applications A to E are respectively arranged in the divided areas 1271a to 1271e. Meanwhile, the MFP 10 (assumed as the MFP 10b) on the import side has the applications A, B, C, D, G, and E installed therein, and with respect to the function designation area 1271, as exemplified in FIG. 17B, icon images of the applications A, B, C, D, G, and E are respectively arranged in the divided areas 1271a to 1271f. That is, the application G installed in the MFP 10b on the import side is not installed in the MFP 10a on the export side.

If the export processing and the import processing according to the present embodiment described above are performed in this state, in the function designation area 1271 of the MFP 10b on the import side, the icon image of the application G that is not installed in the MFP 10a on the export side is deleted. Subsequently, in the function designation area 1271 of the MFP 10b, the respective icon images of the applications A to E commonly installed in the MFP 10a on the export side and the MFP 10b on the import side are respectively arranged in the divided areas 1271a to 1271e, according to the arrangement of the function designation area 1271 of the MFP 10a on the export side exemplified in FIG. 17A.

In the first modification of the present embodiment, the arrangement of the respective icon images of the applications A to E is not changed with respect to the function designation area 1271 in this state, and the icon image of the application G is further arranged.

FIG. 17C illustrates a first arrangement example according to the first modification of the present embodiment. In the first arrangement example, the icon image of the application G is arranged in the divided area 1271f corresponding to a divided area in which any icon image is not arranged in the MFP 10a on the export side, among the divided areas 1271a to 1271f of the function designation area 1271 in the MFP 10b on the import side.

FIG. 17D illustrates a second arrangement example according to the first modification of the present embodiment. In the second arrangement example, the icon image of the application G is arranged on a page different from a page on which icon images of applications commonly included in the MFP 10a on the export side and in the MFP 10b on the import side are arranged, of the function designation area 1271. In the example of FIG. 17D, icon images of the applications A to E commonly included in the MFP 10a on the export side and in the MFP 10b on the import side are respectively arranged, for example, in the divided areas 1271a to 1271e on a first page p1 of the function designation area 1271. The icon image of the application G is arranged, for example, in the divided area 1271a on a second page p2 of the function designation area 1271.

The first arrangement example described above can be applied to a case where, for example, in the function designation area 1271 of the MFP 10b on the import side, the number of applications that are not installed in the MFP 10a on the export side is equal to or less than the number of divided areas in which an icon image is not arranged in the MFP 10a on the export side. Meanwhile, the second arrangement example can be applied even if, on the first page p1 of the function designation area 1271 of the MFP 10b on the import side, the number of applications that are not installed in the MFP 10a on the export side exceeds the number of divided areas in which an icon image is not arranged in the MFP 10a on the export side. The first arrangement example and the second arrangement example can be combined to each other.

### Second Modification of Embodiment

A second modification of the present embodiment is described next. In the second modification of the present embodiment, when one application among the applications installed in the MFP 10a on the export side is not installed in the MFP 10b on the import side, the MFP 10b on the import side is prompted to install the application.

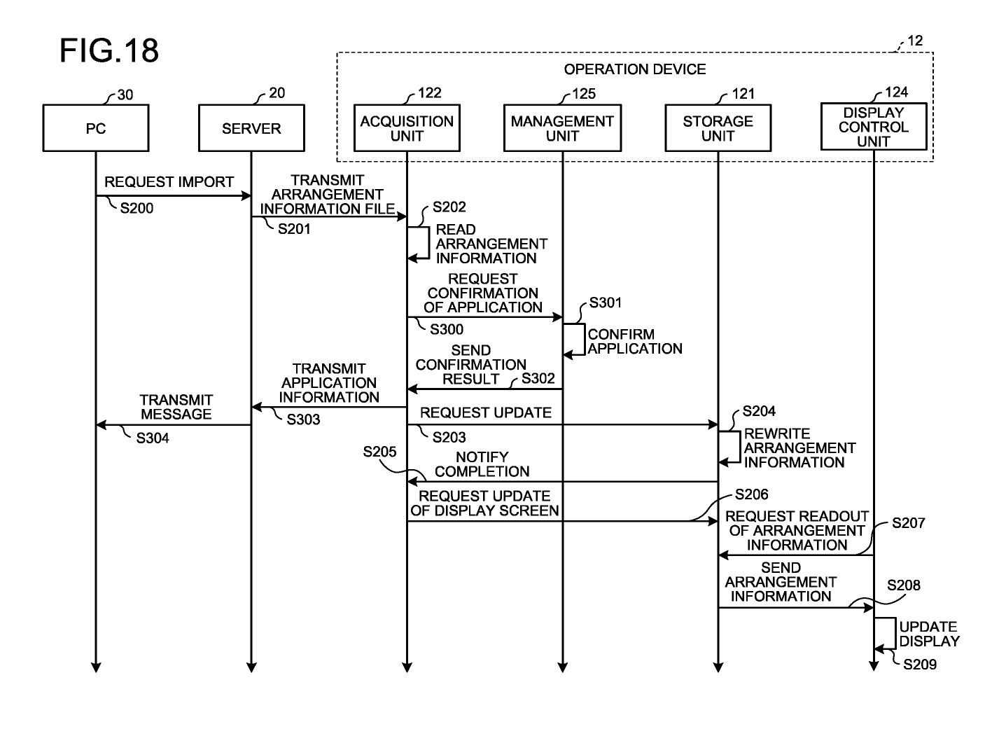

FIG. 18 is a sequence diagram of an example illustrating import processing of arrangement information according to the second modification of the present embodiment. In FIG. 18, elements common to those in FIGS. 1, 7, and 12 are denoted by like reference signs and detailed explanations thereof will be omitted. It is assumed here that the arrangement information acquired from the operation device 12 of the MFP 10a explained with reference to FIG. 11 is imported to other MFPs 10b, 10c, . . . that are connected to the network 2. In the following descriptions, the MFP 10b is explained while representing the MFPs 10b, 10c, . . . .

In the following descriptions, it is assumed that the MFP 10a on the export side has the applications A, B, C, D, and E installed therein, and the MFP 10b on the import side has the applications A, B, C, and D installed therein and the application E is not installed therein.

In FIG. 18, in response to an operation of a user with respect to the PC 30, the PC 30 instructs the server 20 to import arrangement information acquired from the MFP 10a to the MFP 10b (Step S200). The server 20 transmits the arrangement information file acquired from the MFP 10a and stored in the storage unit 121 to the operation device 12 of the MFP 10b in response to the import request from the PC 30 (Step S201). The acquisition unit 122 of the operation device 12 of the MFP 10b acquires the arrangement information file. The acquisition unit 122 reads the arrangement information from the acquired arrangement information file (Step S202).

In the MFP 10b, the acquisition unit 122 requests the management unit 125 to confirm applications to be installed in the MFP 10b (Step S300). The management unit 125 confirms the applications to be managed in the application management area 126 in response to this request (Step S301). The management unit 125 sends application IDs of the respective applications to be managed in the application management area 126 to the acquisition unit 122 as a confirmation result (Step S302).

The acquisition unit 122 extracts information of an application (in this example, the application E) that is installed in the MFP 10a on the export side but is not installed in the MFP 10b on the import side, based on the confirmation result of the applications sent from the management unit 125 and the arrangement information read from the arrangement information file at Step S202. The acquisition unit 122 transmits the extracted information of the application (the application E) to the server 20 (Step S303). The server 20 transmits a message prompting the MFP 10b to install the application E to the PC 30 based on the information of the application (the application E) (Step S304).

When the acquisition unit 122 receives the confirmation result from the management unit 125 at Step S302, the operation device 12 performs the processes at Step S203 to Step S209 in FIG. 12, thereby updating the display of the function designation area 1271. In FIG. 18, it is illustrated that the processes at Step S203 to Step S209 are performed after the confirmation processing of the applications by the management unit 125. However, this example has been described only for explanation purposes, and the present embodiment is not limited to this example. For example, the operation device 12 can perform the processes at Step S203 to Step S209 in parallel to the processes performed by the management unit 125 at Step S300 to Step S302.

According to the embodiment, there is an effect where commonalizing of usability among a plurality of devices with regard to the arrangement of operators on an operation panel can be facilitated.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An operation device that operates an image forming apparatus, the operation device comprising:
an operation unit including a display unit that displays an image and a reception unit that receives an input corresponding to a position of the display unit;
a storage unit that stores therein position information indicating a position of an operator image on the display unit for executing a function installed in at least one of the image forming apparatus and the operation device in association with identification information indicating the corresponding function; and
a processor configured to
cause the display unit to display the operator image corresponding to the identification information thereon, according to the position information and the identification information stored in the storage unit in association with each other,
acquire the identification information and the position information associated with the identification information from outside, and
cause the storage unit to store therein the identification information and the position information.

2. The operation device according to claim 1, wherein
the processor causes the storage unit to store therein a pair of identification information and position information that is in common between a pair of the identification information and the position information acquired from the outside, and a pair of the identification information and the position information stored in the storage unit.

3. The operation device according to claim 1, wherein
the processor causes the storage unit to store therein a pair of identification information and position information that is in common with a pair of the identification information and the position information stored in the storage unit, among pairs of the identification information and the position information acquired from the outside, and a pair of identification information and position information that is not in common with a pair of the identification information and the position information acquired from the outside, among pairs of the identification information and the position information stored in the storage unit, and
the processor causes the operator image corresponding to the pair of position information and identification information that is not in common, which is stored in the storage unit, to be displayed at a position on the display unit not overlapping on the operator image corresponding to the pair of position information and identification information that is in common.

4. The operation device according to claim 3, wherein
the processor manages a display area of the display unit for displaying the operator image in a unit of page capable of displaying the operator images in a predetermined number, and
the processor causes the operator image corresponding to the pair of position information and identification information that is not in common, which is stored in the storage unit, to be displayed on a page different from the page on which the operator image corresponding to the pair of position information and identification information that is in common is displayed.

5. The operation device according to claim 1, wherein
the display unit includes a registration area in which the function to be executed in response to an operation can be registered, at a preset position in a display area,
the storage unit further stores therein identification information indicating the function registered in the registration area and position information indicating a position of the function in the registration area in association with each other, and
the processor further acquires identification information indicating the function to be registered in the registration area and position information indicating the position of the function in the registration area associated with the identification information from the outside, and causes the storage unit to store therein the acquired identification information and position information.

6. The operation device according to claim 1, wherein
the processor is further configured to output the position information and the identification information stored in the storage unit to outside.

7. The operation device according to claim 1, wherein
the processor acquires a pair of the position information and the identification information from a device management apparatus connected thereto via a network, and causes the storage unit to store therein the pair of position information and identification information.

8. The operation device according to claim 7, wherein
the processor notifies the device management apparatus of corresponding identification information of a pair of position information and identification information that is in common with a pair of the identification information and the position information stored in the storage unit, among pairs of the identification information and the position information acquired from the outside.

9. The operation device according to claim 1, wherein the operation device is constituted as a separate unit from the image forming apparatus.

10. A non-transitory computer-readable recording medium that contain an operation program executed by a computer mounted on an operation device that operates an image forming apparatus, wherein
the operation device includes a display unit that displays an image and a reception unit that receives an input corresponding to a position of the display unit, and
the operation program, when executed by the computer, causes the computer to execute:
storing position information indicating a position of an operator image on the display unit for executing a function installed in at least one of the image forming apparatus and the operation device in a storage unit in association with identification information indicating the corresponding function;
causing the display unit to display the operator image corresponding to the identification information thereon, according to the position information and the identification information stored in the storage unit in association with each other; and
acquiring the identification information and the position information associated with the identification information from outside, and causing the storage unit to store therein the identification information and the position information by the storing.

11. The non-transitory computer-readable recording medium according to claim 10, wherein
the computer is caused to execute causing the storage unit to store therein a pair of identification information and position information that is in common between a pair of the identification information and the position information acquired from the outside, and a pair of the identification information and the position information stored in the storage unit.

12. The non-transitory computer-readable recording medium according to claim 10, wherein
the computer is caused to execute causing the storage unit to store therein a pair of identification information and position information that is in common with a pair of the identification information and the position information stored in the storage unit, among pairs of the identification information and the position information acquired from the outside, and a pair of identification information and position information that is not in common with a pair of the identification information and the position information acquired from the outside, among pairs of the identification information and the position information stored in the storage unit, and
the computer is caused to execute causing the operator image corresponding to the pair of position information and identification information that is not in common, which is stored in the storage unit, to be displayed at a position on the display unit not overlapping on the operator image corresponding to the pair of position information and identification information that is in common.

13. The non-transitory computer-readable recording medium according to claim 12, wherein
the computer is caused to execute managing a display area of the display unit for displaying the operator image in a unit of page capable of displaying the operator images in a predetermined number, and
the computer is caused to execute causing the operator image corresponding to the pair of position information and identification information that is not in common, which is stored in the storage unit, to be displayed on a page different from the page on which the operator image corresponding to the pair of position information and identification information that is in common is displayed.

14. The non-transitory computer-readable recording medium according to claim 10, wherein
the display unit includes a registration area in which the function to be executed in response to an operation can be registered, at a preset position in a display area,
the storage unit further stores therein identification information indicating the function registered in the registration area and position information indicating a position of the function in the registration area in association with each other, and
the computer is caused to further execute acquiring identification information indicating the function to be registered in the registration area and position information indicating the position of the function in the registration area associated with the identification information from the outside, and causing the storage unit to store therein the acquired identification information and position information.

15. The non-transitory computer-readable recording medium according to claim 10, wherein
the computer is caused to further execute outputting the position information and the identification information stored in the storage unit to outside.

16. The non-transitory computer-readable recording medium according to claim 10, wherein
the computer is caused to execute acquiring a pair of the position information and the identification information from a device management apparatus connected thereto via a network, and causing the storage unit to store therein the pair of position information and identification information.

17. A device management system including a device management apparatus and an operation device for operating an image forming apparatus, wherein
the operation device includes
an operation unit including a display unit that displays an image and a reception unit that receives an input corresponding to a position of the display unit,
a storage unit that stores therein position information of an operator image on the display unit for executing a function installed in at least one of the image forming apparatus and the operation device in association with identification information indicating the function, and
a first processor configured to
cause the display unit to display the operator image corresponding to the identification information according to the position information and the identification information stored in the storage unit in association with each other,
receive the identification information and the position information associated with the identification information transmitted from the device management apparatus, and cause the storage unit to store therein the identification information and the position information, and
transmit the position information and the identification information stored in the storage unit to the device management apparatus, and
the device management apparatus includes
a second processor configured to
receive a pair of the identification information and the position information transmitted from a predetermined operation device among a plurality of operation devices, and
transmit the pair of the position information and the identification information to an operation device other than the predetermined operation device among the operation devices.

18. The device management system according to claim 17, wherein
the second processor is further configured to receive an input for requesting transmission of a pair of the identification information and the position information with respect to the predetermined operation device and instructing transmission of the pair of the identification information and the position information transmitted from the predetermined operation device to an operation device other than the predetermined operation device among the operation devices.

19. The device management system according to claim 17, wherein
the first processor notifies the corresponding device management apparatus of the corresponding identification information of a pair of position information and identification information that is not in common with a pair of the identification information and the position information stored in the storage unit, among pairs of the identification information and the position information acquired from the device management apparatus, and
the second processor transmits, in response to the notification, information prompting to install the function corresponding to notified identification information to the operation device that performs corresponding notification.

20. The device management system according to claim 17, wherein
the first processor does not cause the display unit to display the operator image corresponding to the identification information of a pair of identification information and position information that is not included in the pairs of the identification information and the position information received from the device management apparatus, among the pairs of the identification information and the position information stored in the storage unit.
